(19) United States
(12) Patent Application Publication
(10) Pub. No.: US 2006/0267728 A1
(43) Pub. Date: Nov. 30, 2006

(54) Padlock that generates a message

(76) Inventors: Richard P. Kamrath, Rolling Hills Estates, CA (US); Julio Sandoval, Lomita, CA (US); George T. Foster, Long Beach, CA (US); Elliot Rudell, Torrance, CA (US)

Correspondence Address: IRELL & MANELLA LLP, 840 NEWPORT CENTER DRIVE, SUITE 400, NEWPORT BEACH, CA, 92660, US

(21) Appl. No.: 11/295,307

(22) Filed: Dec. 5, 2005

Related U.S. Application Data
(60) Provisional application No. 60/684,898, filed on May 25, 2005.

(51) Int. Cl. G05B 19/00

(52) U.S. Cl. 340/5.54; 70/278.4

(57) ABSTRACT

A padlock that can display a message. The padlock includes on output device such as a screen that can display the message. The message can be entered through buttons or keys on the padlock. The screen is controlled by a circuit that can store multiple messages. The circuit can be programmed to operate in different modes. For example, in one mode the message is only displayed when a user enters an appropriate code into the padlock.

### REFERENCE TO RELATED APPLICATION

This application claims priority to provisional Application No. 60/684,898 filed on May 25, 2005.

### BACKGROUND OF THE INVENTION

1. Field of the Invention

The present invention relates to a padlock that can display a message.

2. Prior Art

Padlocks have been used for locking items such as lockers and bicycles. Historically padlocks have provided one function, locking or unlocking an item. Most padlocks include the basic components of a lock and nothing else.

Wordlock marketed a padlock under the name “WORDLOCK” that allows the user to create a message from the combination wheels. Instead of numbers, the wheels have letters that can be arranged into a word or short phrase. The mechanical nature of the “WORDLOCK” limits the context of the messages. There has been marketed a remote controlled padlock by Kidpower of Tennessee. The Kidpower lock, which functions only as a security device, and provides no means for messaging, could be opened by depressing a button on a remote control. The lock had an LED light that became illuminated when the remote button was depressed.

### BRIEF SUMMARY OF THE INVENTION

A padlock that includes an output device and a circuit that controls the output device to generate a message.

### BRIEF DESCRIPTION OF THE DRAWINGS

FIG. 1 is a front view of a padlock;

FIG. 2 is a rear view of the padlock.;

FIG. 3 is an exploded view of the padlock;

FIG. 4 is a schematic of a circuit for the padlock;

FIG. 5 is an illustration of an alternate embodiment that can be attached to an existing padlock.

### DETAILED DESCRIPTION

Disclosed is a padlock that can display a message. The padlock includes on output device such as a screen that can display the message. The message can be entered through buttons or keys on the padlock. The screen is controlled by a circuit that can store multiple messages. The circuit can be programmed to operate in different modes. For example, in one mode the message is only displayed when a user enters an appropriate code in the padlock.

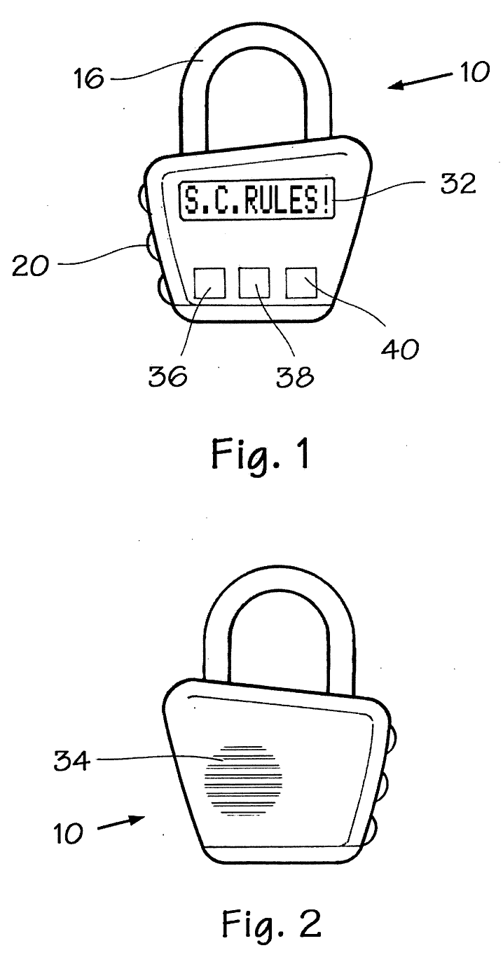

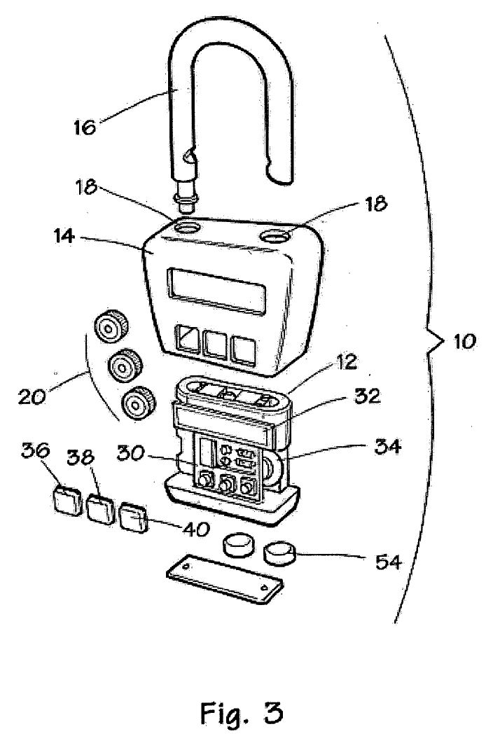

Referring to the drawings more particularly by reference numbers, FIGS. 1, 2 and 3 show an embodiment of a padlock 10. The padlock 10 includes a lock assembly 12 attached to a housing 14. The padlock 10 further includes a shackle 16 that can move relative to housing openings 18. The shackle 16 can be pushed into and out of the lock assembly 12 to lock or unlock the padlock 10. The lock assembly 12 may include combination wheels 20 that can be rotated by a user. Rotation of the wheels 20 to a predetermined combination allows the shackle 16 to be pulled into an unlocked position. Alternatively, or in addition to, the padlock may have a key cylinder (not shown) coupled to the lock assembly so that the padlock can be unlocked by a key (not shown). Alternatively, the lock can be remotely unlocked by a wireless transmitter (not shown).

The padlock 10 may have a printed circuit board assembly 30 within the housing 14. The printed circuit board assembly 30 is connected to an output device such as a screen 32. The screen 32 may be a light emitting diode (LED) or liquid crystal display (LCD) type display. The output device may also include a speaker 34 that is connected to the printed circuit board assembly 30. As another embodiment the output device may only contain a screen or only contain a speaker.

The padlock 10 may also have an input device such as a plurality of buttons 36, 38 and 40 that are connected to the printed circuit board assembly 30. The buttons 36, 38 and 40 can be depressed by the user to create and/or prompt messages generated by the output device. The printed circuit board assembly 30 may contain various circuits that receive input from the input device and control the output device to generate the messages.

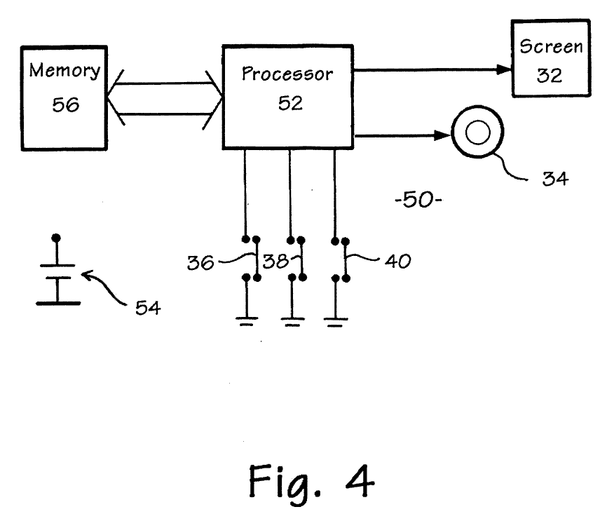

FIG. 4 is a schematic of a padlock circuit 50. The circuit 50 may include a processor 52 with input pins connected to the buttons 36, 38 and 40 and output pins connected to the screen 32 and/or speaker 34. All of the circuits may be powered by a battery 54.

The processor 52 may be connected to memory 56. Alternatively, the processor 52 may contain on-board memory. The memory 56 can store data and/or instructions. The processor 52 may operate in accordance with data and operations of a program to create messages. The processor 52 may then control the output device to generate the message. Multiple messages can be stored in memory 56.

A user can create a message by depressing the buttons 36, 38 and 40. For example, button 38 can be depressed to place the circuit in a program mode. The circuit may display in sequence the letters of the alphabet and numbers 0-9. The user can scroll forward through the sequence by depressing button 36, or back through the sequence by depressing button 40. A letter or number can be selected for the message by depressing button 38. The user can continuously scroll through and select letters and numbers to create a desired message. The message may be saved by depressing and holding button 38. Alternatively, or in addition to, the circuit 50 may contain pre-stored messages that can be reviewed and selected by the user.

The circuit may also allow the user to select how the message is to be displayed. In one mode the message may always be displayed. In another mode the message is only displayed at a set time or at set time intervals. For example, the message may be generated at 3:00 and/or every hour. The message may be displayed only in response to a code entered through the buttons by a user. Thus one user can enter a message that is seen only by another user that can enter a correct code. For example, a first user may enter a message “Party at my house tonight” that can only be seen if the circuit receives an input of “5021”. In this example, the screen may initially be blank. A second user may enter “5”, “0”, “2” and “1”. The screen and/or speaker then generate the message “Party at my house tonight”.

The input code may be entered through the combination wheels 20. The circuit may be configured so that a message can be entered only if the lock is open. The message can be displayed before or after the lock is attached to an object.

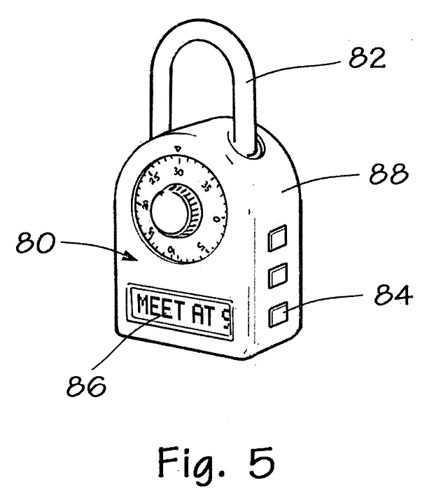

FIG. 5 shows an alternate embodiment of an attachment 80 that can be attached to an existing padlock 82. The attachment 80 may include an input device 84 for entering codes, messages, etc. and an output device 86 for generating the messages. The input 84 and output 86 devices may be attached to a housing 88 that also contains a circuit (not shown) connected to the devices 84 and 86. The attachment 82 may include a speaker and sound generating circuits so that the output might be auditory as well as visual.

The housing 88 may be constructed from a low cost material such as plastic, or the housing 88 may be constructed of a more durable material, such a hardened metal, to withstand tampering or unauthorized removal. The attachment 80 can be assembled to the existing padlock by screws, and/or by slipping the open shackle of the padlock through holes in the attachment housing, and then securing it by the locking of the shackle into the padlock's housing. The attachment 80 may operate in the manner described relative to the padlock shown in FIGS. 1-4, allowing a user to enter messages that are generated by the output device.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

For example, the padlock output device may be, or include, a plurality of lights, such as LEDS, that are illuminated in a pattern selected by the user.

What is claimed is:

1. A padlock, comprising:
a housing;
a shackle that extends from said housing;
a lock mechanism that is attached to said housing and engages said shackle;
an output device that is attached to said housing and generates a message; and,
a circuit that controls said output device to generate said message.

2. The padlock of claim 1, further comprising an input device that receives input to define said message.

3. The padlock of claim 1, wherein said output device is a display screen.

4. The padlock of claim 1, wherein said output device is a speaker.

5. The padlock of claim 2, wherein said input device includes at least one button.

6. The padlock of claim 3, wherein said message is defined by selecting an option displayed by said display screen.

7. The padlock of claim 2, wherein said message is generated in response to an input to said input device.

8. The padlock of claim 1, wherein said circuit includes a memory that stores said message.

9. The padlock of claim 8, wherein said circuit includes a processor that controls a display mode of said message.

10. The padlock of claim 2, wherein said input is a code.

11. A padlock, comprising:
a housing;
a shackle that extends from said housing;
a lock mechanism that is attached to said housing and engages said shackle; and,
message means for defining and generating a message.

12. The padlock of claim 11, wherein said message means includes an input device that receives input to define said message.

13. The padlock of claim 11, wherein said message means includes a display screen.

14. The padlock of claim 11, wherein said message means includes a speaker.

15. The padlock of claim 12, wherein said input device includes at least one button.

16. The padlock of claim 12, wherein said message is defined by selecting an option displayed by said display screen.

17. The padlock of claim 12, wherein said message is generated in response to an input to said input device.

18. The padlock of claim 11, wherein said message means includes a memory that stores said message.

19. The padlock of claim 18, wherein said message means includes a processor that controls a display mode of said message.

20. The padlock of claim 12, wherein said input is a code.

21. An attachment to a padlock, comprising:
an attachment housing adapted to be attached to the padlock;
an output device attached to said attachment housing; and,
a circuit that is coupled to said input device and controls said output device to generate a message.

22. The attachment of claim 21, further comprising an input device that is attached to said attachment housing and receives input to define said message.

23. The attachment of claim 21, wherein said output device is a display screen.

24. The attachment of claim 21, wherein said output device is a speaker.

25. The attachment of claim 22, wherein said message is defined by selecting an option displayed by said display screen.

26. The attachment of claim 22, wherein said message is generated in response to an input into said input device.

27. The attachment of claim 21, wherein said circuit includes a memory that stores said message.

28. The attachment of claim 27, wherein said circuit includes a processor that controls a display mode of said message.

29. The attachment of claim 22, wherein said input is a code.

30. An attachment for a padlock that has a padlock housing, comprising:
an attachment housing adapted to be attached to the padlock housing; and,
message means for generating a message.

31. The attachment of claim 30, wherein said message means includes a display screen.

32. The attachment of claim 30, wherein said message means includes a speaker.

33. The attachment of claim 30, wherein said message means includes an input device attached to said attachment housing and said message can be entered through said input device.

34. The attachment of claim 33, wherein said message is generated in response to an input into said input device.

35. The attachment of claim 30, wherein said message means includes a memory that stores said message.

36. The attachment of claim 35, wherein said message means includes a processor that controls a display mode of said message.

37. The attachment of claim 33, wherein said input is a code.

38. A method for generating a message, comprising:
locking a padlock onto an object; and,
generating an electronic message from the padlock.

39. The method of claim 38, wherein the electronic message is displayed by a display screen.

40. The method of claim 38, wherein the electronic message is audio.

41. The method of claim 38, wherein the message is entered through an input device of the padlock.

42. The method of claim 38, wherein a code is entered to generate the message.

43. The method of claim 38, wherein a code is entered before creating the message.
